(19) United States
(12) Patent Application Publication
(10) Pub. No.: US 2005/0234695 A1
(43) Pub. Date: Oct. 20, 2005

(54) Timing control method of hardware-simulating program and application of the same

(76) Inventors: John C. Wang, Taipei (TW); Mu-Yi Chen, Taipei (TW); Yung-Chieh Lin, Taipei (TW)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/826,991

(22) Filed: Apr. 19, 2004

(51) Int. Cl. G06F 17/50

(52) U.S. Cl. 703/19

(57) ABSTRACT

A timing-control method of a hardware-simulating program can be applied to a software platform for facilitating control program development. The hardware-simulating program can be recorded in any suitable recording medium and defines therein a plurality of simulating elements executed in a predetermined sequence and automatically synchronized at intervals. A time coordinate is referred to realize a current time point when accumulated execution time of each of the simulating elements is equal to or greater than a threshold. The operations of the simulating elements are suspended when the current time point lags behind the expected time point, and restarted when the current time point advances to conform to the expected time point, thereby achieving the purpose of synchronization.

### FIELD OF THE INVENTION

The present invention relates to a timing control method of a software program, and more particularly to a timing control method of a hardware-simulating program. The present invention also relates to a recording medium operable to execute the hardware-simulating program and a software platform for designing hardware control programs thereby according to the hardware-simulating program.

### BACKGROUND OF THE INVENTION

One of the most popular programmable integrated circuits (ICs) is a central processing unit (CPU) applied to a personal computer system. Due to the increasing requirements on rapid and reliable operational ability and a variety of complicate functions of a CPU, lots of time and money are spent in designing a powerful CPU. Accordingly, the CPU is generally costly. For meeting the requirements on competitive prices and flexible applications of consumer IC products, e.g. audio/video apparatus, electrical appliances, electrical toys, watches, personal digital assistants (PDAs), mobile or cellular phones, etc., another programmable IC that is so called as a micro-controller unit (MCU) is used in lieu of the costly CPU in the uni-chip system.

Please refer to FIG. 1 which shows the use of a micro-controller for coordinating a plurality of peripheral equipment devices. For example, the micro-controller 10 controls a display 11, a speaker 12 and an input device such as a keyboard 13 by way of the control program codes stored in a read-only memory (ROM) 101 in the micro-controller 10 and associated with the operations of these peripheral equipment devices. In other words, by varying control program codes inside the micro-controller 10, various controls can be implemented.

For supplying the clients with desired products, micro-controller chip manufacturers are required to provide hardware platforms for the clients to write in control program codes and perform test and debug operations thereby. Generally, the hardware platforms are specific to certain IC products. In other words, different IC products may need different hardware platforms to write in control program codes and perform test and debug operations. Since hardware platforms are high in cost and complicate in architecture, and the circulating period of common IC products, particularly consumer IC products, becomes shorter and shorter, the use of such conventional hardware platforms is time- and cost-inefficient.

### SUMMARY OF THE INVENTION

Therefore, the present invention provides a software platform in lieu of the hardware platform to write in control program codes and perform test and debug operations thereby for improving flexibility and reducing cost.

A first aspect of the present invention relates to a timing control method of a hardware-simulating program. A plurality of simulating elements are defined in the hardware-simulating program and executed in a predetermined sequence. The timing control method comprises steps of referring to a time coordinate to realize a current time point when the hardware-simulating program has been executed to a certain degree; and suspending and then restarting operations of the simulating elements if the current time point has not reached a specified time point yet.

Preferably, the timing control method further comprises steps of accumulating execution time of the simulating elements; and determining the hardware-simulating program has been executed to the certain degree when the execution time has reached or exceeded a threshold period.

Preferably, the simulating elements are executed piecewise in the predetermined sequence. The respective execution time of the simulating elements is accumulatively counted, and the certain degree is determined when accumulated execution time of each of the simulating elements has reached or exceeded the threshold period.

In an embodiment, a period from the simulation starting point to the specified time point can be a multiple or reciprocal multiple of the threshold period.

For example, the period from the simulation starting point to the specified time point can be equal to the threshold period so that the simulation speed of the hardware-simulating program is equal to that of the simulated hardware. Alternatively, the period from the simulation starting point to the specified time point can be double of the threshold period so that the simulated speed by the hardware-simulating program is a half of that of the simulated hardware or a half of the threshold period so that the simulated speed by the hardware-simulating program is double of that of the simulated hardware.

In an embodiment, the hardware-simulating program is for simulating an instruction set executed when a microcontroller controls a plurality of peripheral devices, and the execution time of the simulating elements is accumulated by operating the count of executed machine commands with a machine cycle of the microcontroller.

In an embodiment, the suspended operations of the simulating elements are restarted when the specified time point has been reached.

In an embodiment, the time coordinate is a system clock.

Preferably, the timing control method further comprises steps of attaching time tags to simulation data associated with a specified simulating element; storing the simulation data into a queue; and reading out the simulation data from the queue according to the time tags when it is the turn of the specified simulating element to operate.

According to a second aspect of the present invention, the timing control method comprising steps of referring to a time coordinate to realize a current time point when accumulated execution time of each of the simulating elements is equal to or greater than a threshold; and performing a time-compensating operation if the current time point does not conform to an expected time point.

In an embodiment, when the current time point lags behind the expected time point, the time-compensating operation is performed by suspending the operations of the simulating elements until the current time point advances to conform to the expected time point.

Third and fourth aspects of the present invention relates to a recording medium recorded therein an accessible and executable hardware-simulating program and a software platform for facilitating control program development, which allows a hardware-simulating program to work thereon. The hardware-simulating program defines therein a plurality of simulating elements, and the simulating elements is executed in a predetermined sequence and automatically synchronized at intervals with a time coordinate of a system executing the hardware-simulating program. The simulating elements are automatically synchronized by referring to the time coordinate to realize a current time point whenever the hardware-simulating program has been executed to a certain degree; and performing a time-compensating operation if the current time point does not conform to an expected time point.

In an embodiment, the time coordinate is referred to realize a current time point when accumulated execution time of each of the simulating elements is equal to or greater than a threshold, the operations of the simulating elements are suspended when the current time point lags behind the expected time point, and the operations of the simulating elements are restarted when the current time point advances to conform to the expected time point.

In an embodiment, the accumulated execution time of each of the simulating elements is calculated by timing the count of executed machine commands with a machine cycle of the simulated hardware.

### BRIEF DESCRIPTION OF THE DRAWINGS

The present invention may best be understood through the following description with reference to the accompanying drawings, in which:

FIG. 1 is a schematic block diagram showing a microcontroller and several peripheral equipments controlled thereby;

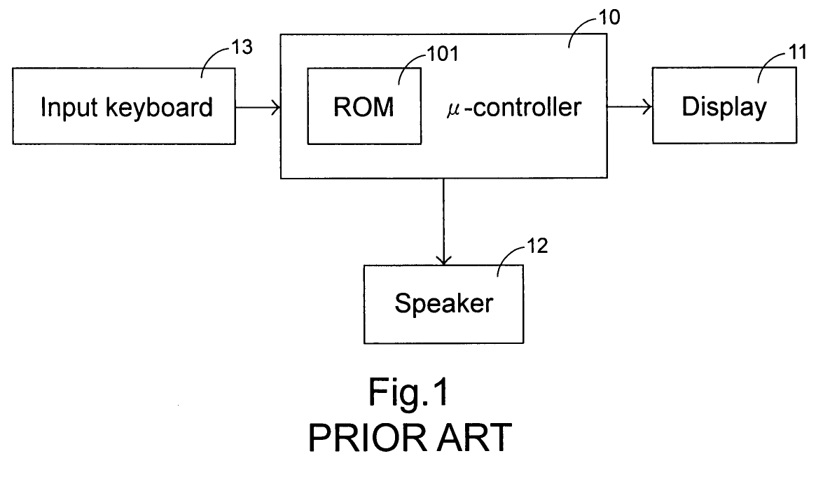

FIG. 2 is a schematic block diagram showing the use of a personal computer to simulate the control scheme of FIG. 1;

FIG. 3A is a schematic diagram exemplifying the piecewise and sequential execution states of a plurality simulating elements defined in the simulating program;

FIG. 3B is a time-sequence plot showing the operation of one of the simulating elements according to an embodiment of the present invention; and

FIG. 4 is a flowchart illustrating the time control method of the hardware-simulating program according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

According to the present invention, a software platform is to be provided for the microcontroller designer to write in control program codes and perform test and debug operations thereby. In principle, a hardware-simulating program is used to execute the function of the hardware so as to achieve the above-mentioned purposes.

One of the simulation technologies was developed based on electronic design automation (EDA) concepts. Since it is necessary to calculate the theoretical performance of each of the logic gates in each of the ICs so as to simulate the behaviors of the IC circuitry, the time spent on simulation is remarkable. For example, a certain operation taking a real micro-controller a few seconds to execute may take a super computer a few days to simulate. As is understood by those skilled in the art, the real time response should be taken into consideration to perfect the design of a micro-controller. Unfortunately, this simulation technology can hardly reflect this important feature.

Another simulation technology, which is considered as one of the most feasible hardware-simulating ways, is to simulate the operation states of the micro-controller at the instruction-set level. It is advantageous in real-time simulation easily implemented with simplified calculation executable by a common personal computer. Therefore, this simulation technology is satisfying in design cost and running speed. Nevertheless, there still are some defects for this conventional simulation technology to be used in the software platform of the present invention.

In general, this simulation technology is developed for education purpose to perform single-chip software simulation, e.g. applied to the non real-time 8051-microcontroller software simulator, or applied to game simulators.

Such simulation technology, due to inherent technical defects, is not suitable to be applied to consumer electronic products. For example, the conventional simulation technology applied to video game consoles is accurate to a level of 1/30˜ 1/10 second (i.e. about 33˜100 milliseconds). On the other hand, the single-chip software simulator such as 8051 microcontroller simulator is even less accurate. The operational speed of these simulators is usually not stable and hardly predictable, and is thus subject to deviation from real situation. The big timing tolerance is adverse to the performance of consumer electronic products, particularly to the sonic devices which requires accuracy up to 1/10000 second (i.e. about 0.1 milliseconds) to well simulate the practical operations of a hardware.

Therefore, the timing control of the simulation technology should be further improved to be applicable to the software platform of the present invention. Once the user can realize the real-time response of the hardware to be simulated, e.g. a microcontroller, the write-in operation of the control program codes and the subsequent test and debug operations will have a precise and reliable base. In order to achieve this purpose, the present invention provides an improved simulating method and a software platform implemented with this improved simulating method, which will be described hereinafter.

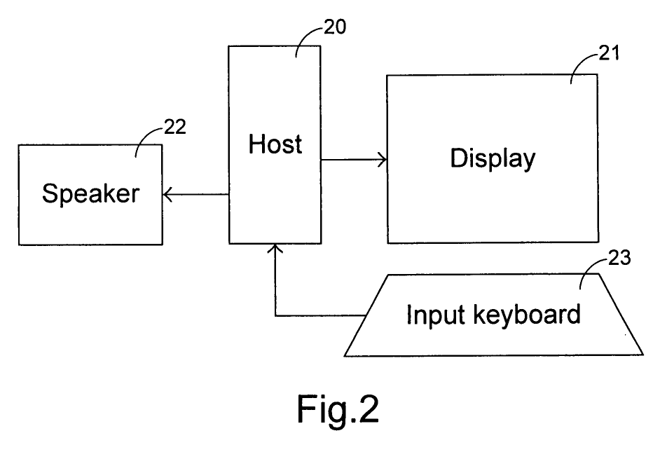

Please refer to FIG. 2. A personal computer system comprising a host 20, an input keyboard 21, a speaker 22 and a display 23 is shown. By way of the personal computer system, a software platform and a timing control method of a hardware-simulating program implemented thereon according to the present invention are exemplified. The instruction set executed when the microcontroller controls the peripheral devices, e.g. the input keyboard 21, speaker 22 and display 23, is simulated with a hardware-simulating program, whose executive codes are derived from source codes by an assembler and a linker applicable to the microcontroller to be simulated.

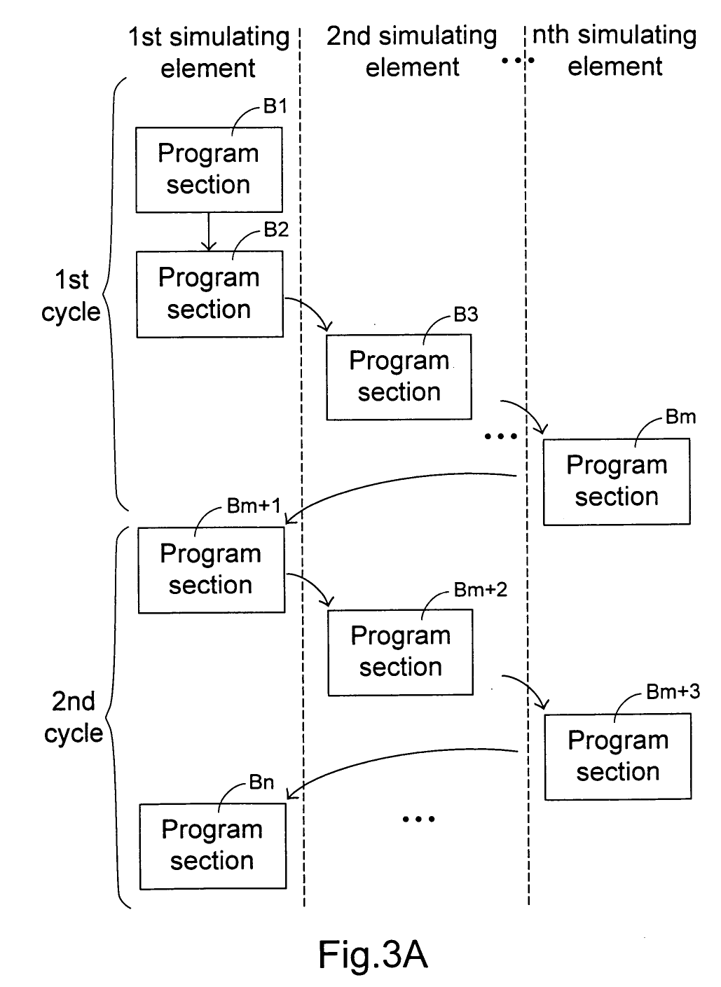

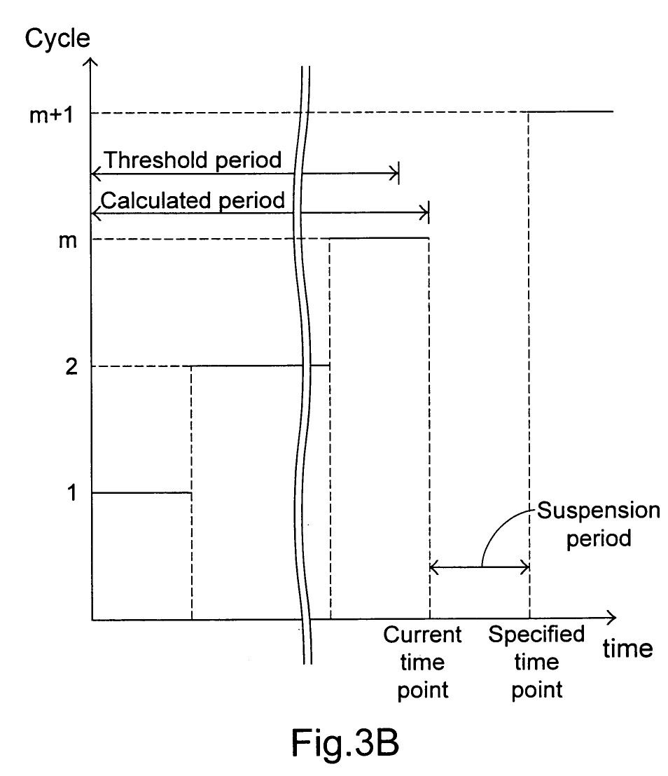

In the hardware-simulating programs, a plurality of simulating elements are defined and executed piecewise according to a predetermined sequence. Prior to executing the simulating elements, a booting procedure of the microcontroller is simulated. The simulated microcontroller starts the execution with the first command indicated by a boot vector realized according to the simulated program counter. Subsequently, the simulating elements are executed in the predetermined sequence. Referring to FIG. 3A, the piecewise and sequential execution states of the simulating elements are exemplified, wherein each of the blocks B1˜Bn represents a section of one of the simulating elements. The execution time of each of the simulating elements is accumulatively counted and recorded. FIG. 3B exemplifies a schematic timing sequence diagram of one of the simulating elements. When the accumulated execution time for each single simulating element has reached or exceeded a threshold period, it means that the simulating elements have been executed to a certain degree. For example, the threshold period is due during the mth cycle of the exemplified hardware-simulating element is performed, as shown in FIG. 3B. Meanwhile, a time coordinate is referred to realize the current time point. By comparing the current time point with a specified time point corresponding to real hardware operation, whether the simulated operational speed is faster than the real speed or not is realized. Once the current time point has not reached the specified time point yet, i.e. the simulated operational speed is faster than the real speed, the operations of the simulating elements are suspended until the specified time point has been reached. Then, next cycle of the operations of the simulating elements are restarted. For example, the (m+1)th and the following cycles of the exemplified hardware-simulating element are performed, as shown in FIG. 3A. When the hardware-simulating program is executed to a further degree, the above-mentioned synchronizing procedure is repeated.

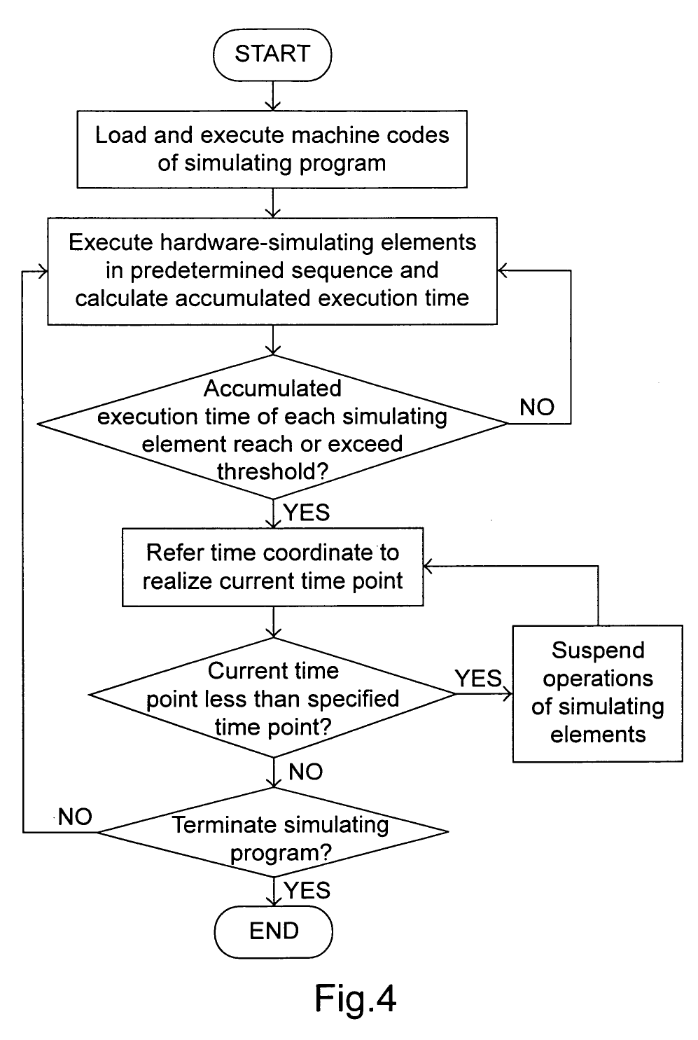

The timing control method of the above embodiment is summarized as a flowchart as shown in FIG. 4.

Since the simulating program mentioned above is used for simulating the peripheral equipments such as the input keyboard, speaker and display as well as the microcontroller, there are preferably data queues corresponding to those hardware-simulating elements for storing the data to be processed, and the data should be attached with time tags. For example, when the input keyboard of the system is pressed down, the hardware-simulating element associated with the input keyboard generates and transmits an entry of image data to the display to be shown. The entry of image data are attached with a time tag, and then stored into a queue corresponding to the hardware-simulating element associated with the display. Afterwards, when it is the turn of the hardware-simulating element associated with the display, the entry of image data are read out from the queue and shown by the display according to the time specified by the time tag. Further with the aid of the timing control method according to the present invention, the simulating operations can be well performed in a nearly real-time mode.

The present invention is particularly useful for simulating the audio control of the microcontroller. When the input keyboard of the system is pressed down, the hardware-simulating element associated with the input keyboard generates and transmits an entry of audio data to the speaker to be outputted. The entry of audio data are attached with a time tag, and then stored into a queue corresponding to the hardware-simulating element associated with the speaker. Afterwards, when it is the turn of the hardware-simulating element associated with the speaker, the entry of audio data are read out from the queue and digital-to analog converted by the hardware-simulating element. When a buffer of the system has been occupied by the audio data, the audio data will be played by the speaker according to the time and sequence specified by the time tags. Since the audio output is much more sensitive than the other kinds of output, the real-time simulation of the audio output becomes more important than the other one. Therefore, the hardware-simulating element associated with the speaker can be further modified to improve the simulated audio effect. For example, in order to assure of correct pitch and tone, the timing accuracy of the speaker control means should be as accurate as about 1/44100 second (about 0.0227 millisecond or 22.7 microsecond). Plural sampled digital signals constitute the entry of audio data, and the sampled digital signals are obtained in a certain sequence by processing the original audio data with an interleaving protocol according to the time tags. The intervals between every two sampled points in the sequence should be made equal to comply with the specification of common buffers. By this way, after the digital-to-analog converting operation, the speaker can be driven to output correct pitch and tone.

According to an embodiment of the present invention, the estimated execution time of each block can be realized by timing the machine cycle of the simulated object, e.g. 0.5 microsecond for microcontroller, by the count of machine commands having been executed. As for the setting of the threshold period, it depends on the required real-time simulating performance and the acceptable operation amount of the system. If the specified time points have a small interval, the synchronizing accuracy would be improved. The operation amount of the system, however, would be enormous. On the other hand, the system clock can be used as the time coordinate to be referred to. By setting the specified time point in the time coordinate at a level approximating to the calculated accumulative execution time of each simulating element, the hardware-simulating program will be executed at a normal speed as that of the simulated hardware. The specified time point can also be set to be quicker or slower than the calculated accumulative execution time of the simulating element so as to change the execution speed of the simulating program. For example, if the specified time point is set as a half of the calculated accumulative execution time, the execution speed of the hardware-simulating program becomes double of that of the simulated hardware. Therefore, the simulation is performed at a high speed. On the contrary, if the specified time point is set as double of the calculated accumulative execution time, the execution speed of the hardware-simulating program becomes a half of that of the simulated hardware, and the simulation is performed at a low speed. This is particularly useful for observing the desired portion clearly at a low speed, while skipping the less important portion quickly at a high speed to reduce verifying time. By this way, the simulating operations can be dynamically adjusted at intervals so as to approximate real-time performance.

Since human cannot tell the video/audio signals having a deviation period less than 40 milliseconds, it is proper to set the execution time of each section of the hardware-simulating elements mentioned in the above embodiment to be about 20 milliseconds. In view of the burden of a common computer system, it is proper to set the interval of every two adjacent specified points to be 40 milliseconds. To this degree, satisfactory real-time interaction can be achieved.

It is clear from the above description that the simulation conducted according to the present invention approximates the real state of the simulated hardware due to the synchronization mechanism. Accordingly, the user can accurately realize the real response of the simulated hardware, e.g. microcontroller. By using the software platform implementing the present simulating program with timing control, the write-in, test and debug operations can be easily performed with control program codes. Since the real-time simulation can be achieved by the present software platform, the cost required for hardware platform can thus be saved. Moreover, the software platform according to the present invention can be efficiently refreshed with the development of consumer electric produces at low cost.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A timing control method of a hardware-simulating program, a plurality of simulating elements being defined in said hardware-simulating program and executed in a predetermined sequence, said timing control method comprising steps of:
referring to a time coordinate to realize a current time point when said hardware-simulating program has been executed to a certain degree; and
suspending and then restarting operations of said simulating elements if said current time point has not reached a specified time point yet.

2. The timing control method according to claim 1 further comprising steps of:
accumulating execution time of said simulating elements; and
determining said hardware-simulating program has been executed to said certain degree when said execution time has reached or exceeded a threshold period.

3. The timing control method according to claim 2 wherein said simulating elements are executed piecewise in said predetermined sequence, respective execution time of said simulating elements is accumulatively counted, and said certain degree is determined when accumulated execution time of each of said simulating elements has reached or exceeded said threshold period.

4. The timing control method according to claim 2 wherein a period from the simulation starting point to said specified time point is a multiple or reciprocal multiple of said threshold period.

5. The timing control method according to claim 4 wherein said period from the simulation starting point to said specified time point is equal to said threshold period so that the simulation speed of said hardware-simulating program is equal to that of the simulated hardware.

6. The timing control method according to claim 4 wherein said period from the simulation starting point to said specified time point is double of said threshold period so that the simulated speed by said hardware-simulating program is a half of that of the simulated hardware.

7. The timing control method according to claim 4 wherein said period from the simulation starting point to said specified time point is a half of said threshold period so that the simulated speed by said hardware-simulating program is double of that of the simulated hardware.

8. The timing control method according to claim 2 wherein said hardware-simulating program is for simulating an instruction set executed when a microcontroller controls a plurality of peripheral devices, and said execution time of said simulating elements is accumulated by operating the count of executed machine commands with a machine cycle of said microcontroller.

9. The timing control method according to claim 1 wherein said operations of said simulating elements are restarted when said specified time point has been reached.

10. The timing control method according to claim 1 wherein said time coordinate is a system clock.

11. The timing control method according to claim 1 further comprising steps of:
attaching time tags to simulation data associated with a specified simulating element;
storing said simulation data into a queue; and
reading out said simulation data from said queue according to said time tags when it is the turn of said specified simulating element to operate.

12. A timing control method of a hardware-simulating program, a plurality of simulating elements being defined in said hardware-simulating program and executed in a predetermined sequence, said timing control method comprising steps of:
referring to a time coordinate to realize a current time point when accumulated execution time of each of said simulating elements is equal to or greater than a threshold; and
performing a time-compensating operation if said current time point does not conform to an expected time point.

13. The timing control method according to claim 12 wherein when said current time point lags behind said expected time point, said time-compensating operation is performed by suspending the operations of said simulating elements until said current time point advances to conform to said expected time point.

14. The timing control method according to claim 12 wherein said expected time point is equal to said threshold so that the simulation speed of said hardware-simulating program is equal to that of the simulated hardware.

15. The timing control method according to claim 4 wherein said expected time point is a multiple of said threshold so that the simulated speed by said hardware-simulating program is a reciprocal multiple of that of the simulated hardware.

16. The timing control method according to claim 4 wherein said expected time point is a reciprocal multiple of said threshold period so that the simulated speed by said hardware-simulating program is a multiple of that of the simulated hardware.

17. A recording medium recorded therein an accessible and executable hardware-simulating program, said hardware-simulating program defining therein a plurality of simulating elements, and said simulating elements being executed in a predetermined sequence and automatically synchronized at intervals with a time coordinate of a system executing said hardware-simulating program, wherein said simulating elements are automatically synchronized by:
referring to said time coordinate to realize a current time point whenever said hardware-simulating program has been executed to a certain degree; and
performing a time-compensating operation if said current time point does not conform to an expected time point.

18. A software platform for facilitating control program development, allowing a hardware-simulating program to work thereon, said hardware-simulating program defining therein a plurality of simulating elements, and said simulating elements being executed in a predetermined sequence and automatically synchronized at intervals with a time coordinate of a system executing said hardware-simulating program, wherein said simulating elements are automatically synchronized by:
referring to said time coordinate to realize a current time point whenever said hardware-simulating program has been executed to a certain degree; and
performing a time-compensating operation if said current time point does not conform to an expected time point.

19. The software platform according to claim 18 wherein said time coordinate is referred to realize a current time point when accumulated execution time of each of said simulating elements is equal to or greater than a threshold, the operations of said simulating elements are suspended when said current time point lags behind said expected time point, and the operations of said simulating elements are restarted when said current time point advances to conform to said expected time point.

20. The software platform according to claim 19 wherein said accumulated execution time of each of said simulating elements is calculated by timing the count of executed machine commands with a machine cycle of the simulated hardware.
